(19) United States
(12) Patent Application Publication
(10) Pub. No.: US 2025/0124870 A1
(43) Pub. Date: Apr. 17, 2025

(54) DISPLAY DEVICE DRIVING METHOD AND DISPLAY DEVICE

(71) Applicant: JDI Design and Development G.K., Tokyo (JP)

(72) Inventor: Eiji IWAUCHI, Tokyo (JP)

(73) Assignee: JDI Design and Development G.K., Tokyo (JP)

(21) Appl. No.: 18/912,619

(22) Filed: Oct. 11, 2024

(30) Foreign Application Priority Data
Oct. 11, 2023 (JP) 2023-176059

(51) Int. Cl. G09G 3/3233

(52) U.S. Cl. CPC G09G 3/3233; G09G 2300/0814; G09G 2300/0842; G09G 2320/0233; G09G 2320/045; G09G 2360/16

(57) ABSTRACT

A display device driving method includes: converting a plurality of first luminance signals corresponding to a plurality of pixels to a plurality of second luminance signals; and driving a display component based on the plurality of second luminance signals. The converting includes: calculating a weight corresponding to a lighting period of the display component, based on the plurality of first luminance signals or the plurality of second luminance signals; calculating a cumulative value that is an accumulation of a value corresponding to the weight; calculating, based on the cumulative value, a reduction rate at which each of the plurality of first luminance signals is to be reduced; and calculating the plurality of second luminance signals, based on the reduction rate and the plurality of first luminance signals.

### CROSS REFERENCE TO RELATED APPLICATION

The present application is based on and claims priority of Japanese Patent Application No. 2023-176059 filed on Oct. 11, 2023. The entire disclosure of the above-identified application, including the specification, drawings and claims is incorporated herein by reference in its entirety.

### FIELD

The present disclosure relates to a display device driving method and a display device.

### BACKGROUND

Conventionally, display devices in which each pixel includes a self-luminous element, such as organic EL (electroluminescent) display devices, have been developed. In such display devices, it is known that self-luminous elements such as organic EL elements are degraded.

In the invention described in Patent Literature (PTL) 1, peak luminance control according to a lighting period is performed based on a preset luminance attenuation curve. Here, the luminance attenuation curve means a graph illustrating the change in the attenuation rate (luminance maintenance rate) of organic EL elements versus the lighting period. In the invention described in PTL 1, an optimum luminance attenuation curve is used according to the load expected in the organic EL elements, so as to prolong the life of the organic EL elements, while inhibiting deterioration of the image quality of a display device.

In the invention described in PTL 2, the peak luminance across a plurality of pixels is decreased to the luminance at which the most degraded pixel among the plurality of pixels included in a display device can display. In this manner, the luminance of a specific pixel is inhibited from being decreased, so as to inhibit the image quality of the display device from being impaired.

### CITATION LIST

### Patent Literature

PTL 1: International Publication WO2015/174077
PTL 2: U.S. Pat. No. 10,867,551

### SUMMARY

### Technical Problem

However, in the display device described in PTL 1, since the preset luminance attenuation curve is used, when the actual amount of luminance attenuation of each organic EL element is smaller than an expected amount of luminance attenuation, the peak luminance will be set lower than necessary. Therefore, the attractiveness of video displayed by the display device will be reduced more than necessary.

In addition, in the display device described in PTL 2, when there is even one pixel among the plurality of pixels that is severely degraded, since the luminance of the other pixels is significantly decreased to match that pixel, the attractiveness of video displayed by the display device is reduced.

The present disclosure provides a display device driving method and the like that can prolong the life of a plurality of pixels included in a display device, while inhibiting the luminance of the plurality of pixels from being decreased more than necessary.

### Solution to Problem

To achieve the above, a display device driving method according to an aspect of the present disclosure is a display device driving method of driving a display device that includes a display component including a plurality of pixels, the display device driving method including: converting a plurality of first luminance signals corresponding to the plurality of pixels to a plurality of second luminance signals; and driving the display component based on the plurality of second luminance signals, wherein the converting includes: calculating a weight corresponding to a lighting period of the display component, based on the plurality of first luminance signals or the plurality of second luminance signals; calculating a cumulative value that is an accumulation of a value corresponding to the weight; calculating, based on the cumulative value, a reduction rate at which each of the plurality of first luminance signals is to be reduced; and calculating the plurality of second luminance signals, based on the reduction rate and the plurality of first luminance signals.

To achieve the above, a display device according to an aspect of the present disclosure is a display device that includes a display component including a plurality of pixels, the display device including: a converter that converts a plurality of first luminance signals corresponding to the plurality of pixels to a plurality of second luminance signals, the converter including: a weight calculator that calculates a weight corresponding to a lighting period of the display component, based on the plurality of first luminance signals or the plurality of second luminance signals; a cumulative value calculator that calculates a cumulative value that is an accumulation of a value corresponding to the weight; a reduction rate calculator that calculates, based on the cumulative value, a reduction rate at which each of the plurality of first luminance signals is to be reduced; and a second luminance signal calculator that calculates the plurality of second luminance signals, based on the reduction rate and the plurality of first luminance signals, wherein the display component is driven based on the plurality of second luminance signals.

Note that these general or specific aspects may be implemented as a system, a method, an integrated circuit, a computer program, a computer-readable recording medium such as a compact disc read-only memory (CD-ROM), or as any combination of systems, methods, integrated circuits, computer programs, and recording media. The recording medium may be a non-transitory recording medium.

### Advantageous Effects

According to the present disclosure, it is possible to provide a driving method of a display device and the like that can prolong the life of a plurality of pixels included in the display device, while inhibiting the luminance of the plurality of pixels from being decreased more than necessary.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating a configuration example of a display device according to Embodiment 1.

FIG. 2 is a diagram illustrating an example of the configuration of a pixel set according to Embodiment 1.

FIG. 3 is a circuit diagram illustrating an example of the configuration of a pixel according to Embodiment 1.

FIG. 4 is a block diagram illustrating an example of the configuration of a control circuit according to Embodiment 1.

FIG. 5 is a block diagram illustrating the configuration of a converter according to Embodiment 1.

FIG. 6 is a graph illustrating an example of the relationship between normalized luminance and a weight according to Embodiment 1.

FIG. 7 is a graph illustrating an example of the relationship between a cumulative value and a reduction rate according to Embodiment 1.

FIG. 8 is a flowchart illustrating the flow of a driving method of the display device according to Embodiment 1.

FIG. 9 is a block diagram illustrating the configuration of a converter according to Embodiment 2.

FIG. 10 is a graph illustrating an example of the relationship between the ambient temperature and a second weight according to Embodiment 2.

### DESCRIPTION OF EMBODIMENTS

Hereinafter, embodiments of the present disclosure will be described with reference to the drawings. Note that each of the embodiments described below shows a specific example of the present disclosure. Therefore, the numerical values, shapes, materials, constituent elements, the arrangement and connection of the constituent elements, processes, and the order of the processes, etc., indicated in the embodiments described below are mere examples and do not intend to limit the present disclosure.

Note that the drawings are represented schematically and are not necessarily precise illustrations. In the drawings, essentially the same constituent elements share the same reference signs, and redundant descriptions will be omitted or simplified.

### Embodiment 1

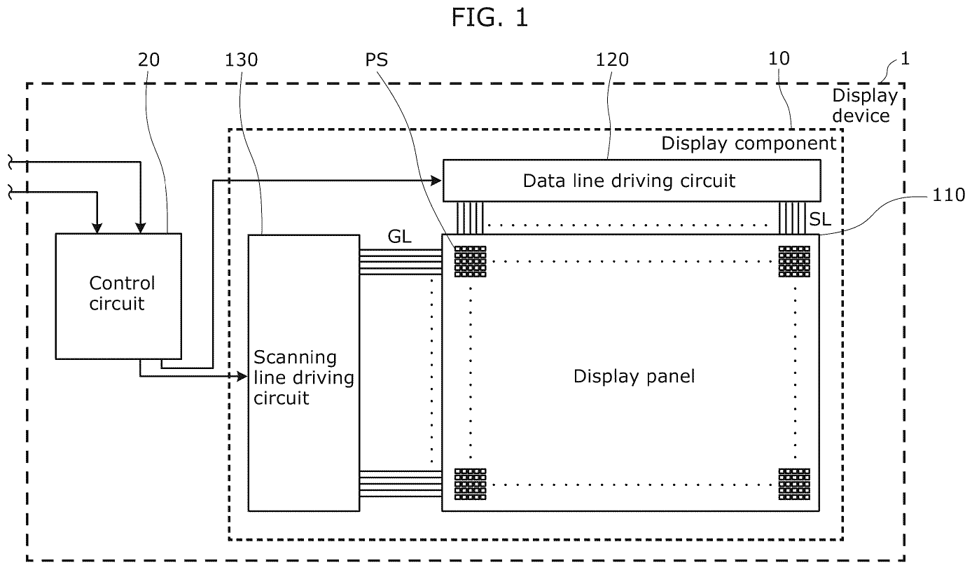

A display device and a driving method thereof according to Embodiment 1 will be described by using FIG. 1. FIG. 1 is a block diagram illustrating a configuration example of display device 1 according to the present embodiment.

Note that, in the present embodiment, a description will be given of an example in which display device 1 is an organic EL display.

Display device 1 is a display including display component 10 that includes a plurality of pixels P. In the present embodiment, the actual display luminance of the plurality of pixels P is degraded over time. Hereinafter, the definitions of terms used in the present embodiment will be described.

In the present embodiment, “physical amount of degradation” means the amount of decrease in the actual display luminance (amount of emission) over time when a current corresponding to luminance data obtained from a video signal, that is, uncorrected luminance data, is supplied to a pixel. The physical amount of degradation varies between individual pixels.

In the present embodiment, “attenuation property of amount of emission” means the amount of attenuation of the actual display luminance over time as determined by design. Although the physical amount of degradation cannot be controlled by design (varies depending on video to be displayed), the attenuation property of the amount of emission can be controlled by design. The attenuation property of the amount of emission becomes the same in all the display pixels.

### 1. Configuration of Display Device

As illustrated in FIG. 1, display device 1 includes display component 10 and control circuit 20.

Display component 10 includes display panel 110, data line driving circuit 120, and scanning line driving circuit 130. Display component 10 is driven based on a plurality of correction signals that are output by control circuit 20.

Display panel 110 includes a plurality of pixel sets PS arranged in a matrix, and a plurality of scanning lines GL and a plurality of data lines SL that are connected to the pixel sets PS.

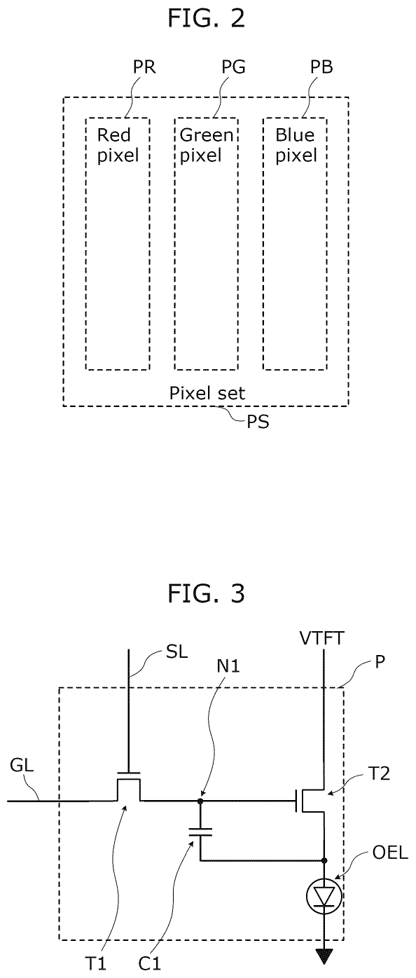

The configuration of pixel set PS will be described by using FIG. 2 and FIG. 3. FIG. 2 is a diagram illustrating an example of the configuration of pixel set PS according to the present embodiment. FIG. 3 is a circuit diagram illustrating an example of the configuration of pixel P according to the present embodiment. Pixel set PS according to the present embodiment includes a plurality of pixels P. In the present embodiment, as illustrated in FIG. 2, pixel set PS includes red pixel PR, green pixel PG, and blue pixel PB. Each of red pixel PR, green pixel PG, and blue pixel PB included in pixel set PS is an example of pixel P according to the present embodiment. In other words, display panel 110 includes the plurality of pixels P, and the plurality of pixels P include pixels corresponding to a plurality of emission colors. For example, a plurality of red pixels PR, a plurality of green pixel PG, and a plurality of blue pixels PB are included in the plurality of pixels P.

In the present embodiment, each of the plurality of pixels P includes, as illustrated in FIG. 3, organic EL element OEL, selection transistor T1, drive transistor T2, and capacitance element C1.

Selection transistor T1 switches between selection and unselection of pixel P according to a drive signal that is output from control circuit 20. Selection transistor T1 is a thin film transistor (TFT), and a gate terminal is connected to scanning line GL, a source terminal is connected to data line SL, and a drain terminal is connected to node N1.

Drive transistor T2 supplies a drive current corresponding to the voltage value of data line SL to organic EL element OEL. Drive transistor T2 is a thin film transistor, and a gate terminal is connected to node N1, a source terminal is connected to an anode electrode of organic EL element OEL, and voltage VTFT is supplied to a drain terminal from a power supply (not illustrated).

Organic EL element OEL is a light emitting element that emits light according to the drive current. The drive current is supplied from drive transistor T2. In organic EL element OEL, an anode electrode is connected to the source terminal of drive transistor T2, and a cathode electrode is grounded.

In capacitance element C1, one end is connected to node N1, and the other end is connected to the source terminal of drive transistor T2.

Data line driving circuit 120 supplies, to data lines SL, voltages corresponding to a plurality of correction signals that are output from control circuit 20.

Scanning line driving circuit 130 supplies, to scanning lines GL, a voltage corresponding to the drive signal that is output from control circuit 20.

Note that, in the present embodiment, although an example has been described in which selection transistor T1 and drive transistor T2 are N-type TFTs, they may be P-type TFTs. Also in this case, capacitance element C1 is connected between the gate and source of drive transistor T2.

Control circuit 20 is a circuit that controls the display of video in display panel 110, and is constituted by using, for example, a timing controller (TCON) or the like. Control circuit 20 sequentially obtains a luminance signal (hereinafter also referred to as a first luminance signal) of each of the plurality of pixels P constituting display panel 110 from, for example, a video signal. Furthermore, control circuit 20 performs correction on each first luminance signal. The correction of the first luminance signal is performed according to, for example, the physical amount of degradation of organic EL element OEL of pixel P corresponding to the first luminance signal to be corrected, and the attenuation property of the amount of emission. Hereinafter, a plurality of first luminance signals after the correction by control circuit 20 are referred to as a plurality of correction signals. Control circuit 20 outputs the plurality of correction signals to data line driving circuit 120. Note that, in the following description, pixel P corresponding to the first luminance signal to be corrected that is currently processed in control circuit 20 is referred to as pixel P to be corrected.

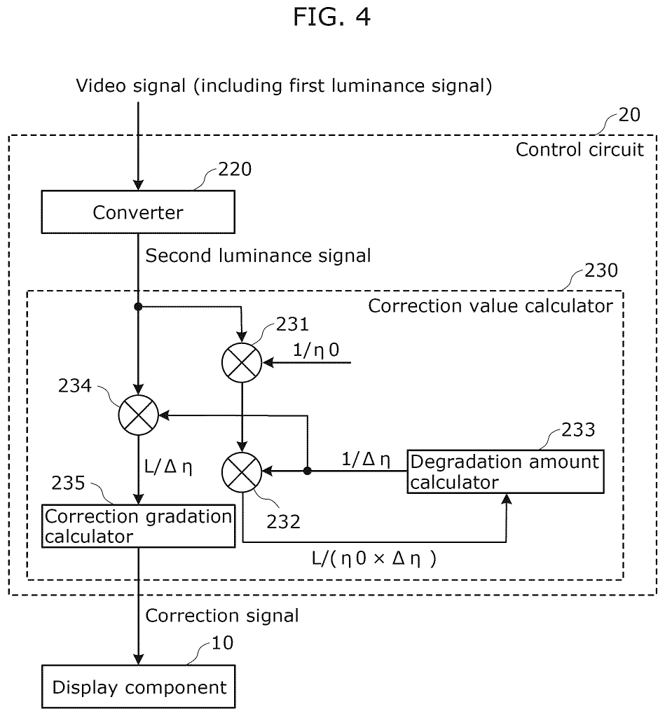

Control circuit 20 will be described by using FIG. 4. FIG. 4 is a block diagram illustrating an example of the configuration of control circuit 20 according to the present embodiment. Display component 10 is also illustrated in FIG. 4. As illustrated in FIG. 4, control circuit 20 includes converter 220 and correction value calculator 230.

Converter 220 is a processing unit that converts a plurality of first luminance signals corresponding to a plurality of pixels P into a plurality of second luminance signals. Converter 220 uniformly reduces the first luminance signals by the same reduction rate for all the pixels P of display panel 110. Display component 10 according to the present embodiment is driven based on the plurality of second luminance signals. Here, display component 10 being driven based on the plurality of second luminance signals is not limited to a case where display component 10 is driven based on the plurality of second luminance signals themselves, but also includes a case where display component 10 is driven based on a plurality of correction signals obtained by further correcting the plurality of second luminance signals.

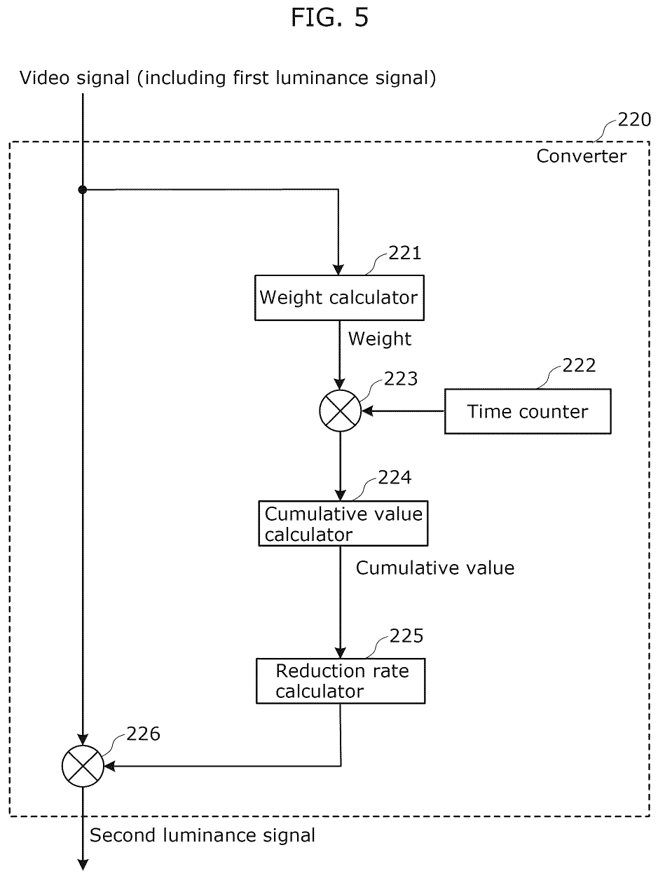

The configuration of converter 220 will be described by using FIG. 5. FIG. 5 is a block diagram illustrating the configuration of converter 220 according to the present embodiment. As illustrated in FIG. 5, converter 220 includes weight calculator 221, time counter 222, multiplier 223, cumulative value calculator 224, reduction rate calculator 225, and multiplier 226.

More particularly, converter 220 obtains the first luminance signal from the video signal for displaying an image on display component 10.

Weight calculator 221 calculates a weight corresponding to the lighting period of display component 10, based on the plurality of first luminance signals or the plurality of second luminance signals. In the present embodiment, weight calculator 221 calculates a weight based on a plurality of first luminance signals. More specifically, weight calculator 221 calculates a weight based on the average picture level (APL) of a plurality of first luminance signals. The APL corresponds to the average of a plurality of first luminance signals. The average of the APL in a predetermined period may be used as the APL. Weight calculator 221 outputs a signal corresponding to the calculated weight to multiplier 223.

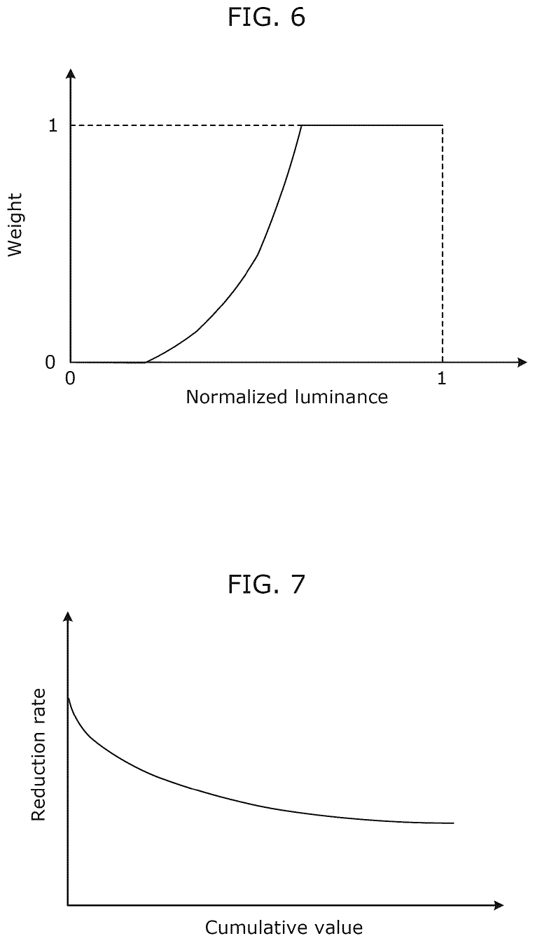

A calculation method of weight in weight calculator 221 will be described by using FIG. 6. FIG. 6 is a graph illustrating an example of the relationship between the normalized luminance and the weight according to the present embodiment. In the present embodiment, the normalized luminance is the normalized APL. As illustrated in FIG. 6, the weight is, for example, a value of 0 or more to 1 or less, and is increased as the normalized luminance is increased. Weight calculator 221 calculates a weight by using, for example, the graph as illustrated in FIG. 6, a function for the APL and the weight, a look-up table, or the like.

When display device 1 is a color display, weight calculator 221 may calculate the weight for each of emission colors, such as red, green, and blue.

Note that, in the present embodiment, although weight calculator 221 calculates a weight based on the APL of a plurality of first luminance signals, the calculation method of the weight in weight calculator 221 is not limited to this. For example, weight calculator 221 may calculate the weight based on the maximum luminance of a plurality of first luminance signals. That is, weight calculator 221 may calculate the weight based on the first luminance signal indicating the maximum luminance among a plurality of first luminance signals corresponding to one frame. In addition, weight calculator 221 may calculate the weight based on the average of the maximum luminances of a plurality of first luminance signals in a predetermined period.

In addition, weight calculator 221 may calculate the weight based on a plurality of second luminance signals, which are output signals of converter 220. In this case, a plurality of second luminance signals, which are output signals of converter 220, are input to weight calculator 221. For example, weight calculator 221 may calculate the weight based on the APL of the plurality of second luminance signals, the maximum luminance, or the average of maximum luminances in the predetermined period, or the like.

In addition, weight calculator 221 may calculate the weight based on signals obtained by further correcting a plurality of second luminance signals. For example, weight calculator 221 may calculate the weight based on a plurality of correction signals, which are output signals of control circuit 20. In this case, a plurality of correction signals, which are output signals of control circuit 20, are input to weight calculator 221. For example, weight calculator 221 may calculate the weight based on the APL of a plurality of correction signals, the maximum luminance, or the average of maximum luminances in the predetermined period, or the like.

In addition, weight calculator 221 may calculate the weight based on both a plurality of first luminance signals and a plurality of second luminance signals. For example, weight calculator 221 may calculate the weight based on the product of a first luminance signal and a second luminance signal corresponding to each pixel.

Time counter 222 illustrated in FIG. 5 outputs a signal corresponding to elapsed time. In the present embodiment, a signal is output to multiplier 223 each time the predetermined period elapses.

Multiplier 223 is a processing unit that multiplies a signal corresponding to the weight, and a signal corresponding to the predetermined period. Multiplier 223 outputs, to cumulative value calculator 224, a signal corresponding to a multiplication result of the signal corresponding to the weight and the signal corresponding to the predetermined period. Note that when display device 1 is a color display, multiplier 223 may multiply the signal corresponding to the weight, and the signal corresponding to the predetermined period for each of emission colors, such as red, green, and blue.

Cumulative value calculator 224 is a processing unit that calculates a cumulative value that is an accumulation of a value corresponding to the weight. In the present embodiment, cumulative value calculator 224 calculates, as a cumulative value, a value that is an accumulation of a value corresponding to the period obtained by multiplying the weight and the period from the time when driving of display device 1 is started, and outputs the cumulative value to reduction rate calculator 225. The cumulative value calculated here corresponds to the effective lighting period (drive period) in a case where pixel P is continued to be lit at a predetermined luminance. Accordingly, the effective lighting period according to the actual usage condition of display device 1 can be obtained. Therefore, the degree of degradation of pixel P can be more correctly predicted.

In addition, the cumulative value calculated in cumulative value calculator 224 is maintained without being reset, even when driving of display device 1 is stopped (when a main power supply of display device 1 is switched from an ON state to an OFF state, or the like). Note that when display device 1 is a color display, cumulative value calculator 224 may calculate the cumulative value for each of emission colors, such as red, green, and blue.

Reduction rate calculator 225 calculates the reduction rate for reducing each of a plurality of first luminance signals based on the cumulative value calculated by cumulative value calculator 224. Note that when display device 1 is a color display, reduction rate calculator 225 may calculate the reduction rate (color-specific reduction rate) for each of emission colors, such as red, green, and blue, and may output the minimum value among them as the reduction rate. That is, reduction rate calculator 225 may calculate a plurality of color-specific reduction rates corresponding to a plurality of emission colors, respectively, and may select the minimum color-specific reduction rate among the plurality of color-specific reduction rates as the reduction rate. Accordingly, since the reduction rate can be determined according to pixel P of the most degraded emission color, the progression of degradation of pixel P can be inhibited to a minimum.

Here, the relationship between the cumulative value and the reduction rate will be described by using FIG. 7. FIG. 7 is a graph illustrating an example of the relationship between the cumulative value and the reduction rate according to the present embodiment. As illustrated in FIG. 7, the reduction rate calculated by reduction rate calculator 225 is decreased as the cumulative value is increased. The reduction rate is determined based on the degradation property of a plurality of pixels P, that is, the attenuation property of the amount of emission. For example, the reduction rate may be determined based on the degradation property of pixel P having an intermediate degree of degradation property between the degradation property of the most degraded pixel P and the degradation property of the least degraded pixel P among a plurality of pixels P. That is, the relationship between the cumulative value and the reduction rate may be determined based on the relationship between the lighting period in a case where this pixel P is continued to be lit at expected luminance and the actual display luminance. Accordingly, by reducing the luminance, it is possible to inhibit the luminance of display component 10 from being decreased more than necessary, while inhibiting degradation of the plurality of pixels P. In addition, in the determination of the reduction rate, the reduction rate corresponding to an effective lighting period can be determined by using the cumulative value of a value corresponding to the weight, instead of the lighting period of the plurality of pixels P. Therefore, the reduction rate can be determined based on the more correctly estimated degree of degradation of the plurality of pixels P. Accordingly, it is possible to inhibit the attractiveness of display device 1 from being reduced by decreasing the luminance of the plurality of pixels P more than necessary, and to inhibit the life of display device 1 from being shortened by increasing the luminance more than necessary as compared with the degree of degradation of the plurality of pixels P.

Multiplier 226 is an example of a second luminance signal calculator that calculates a plurality of second luminance signals based on the reduction rate and the plurality of first luminance signals. Multiplier 226 calculates a plurality of second luminance signals by multiplying a signal corresponding to the reduction rate that is output by reduction rate calculator 225, and the plurality of first luminance signals.

Correction value calculator 230 illustrated in FIG. 4 calculates, for each pixel P, a correction signal obtained by correcting a second luminance signal according to the amount of degradation. Correction value calculator 230 includes multipliers 231, 232, and 234, degradation amount calculator 233, and correction gradation calculator 235. The operation of each constituent element of correction value calculator 230 will be described later.

### 2. Driving Method

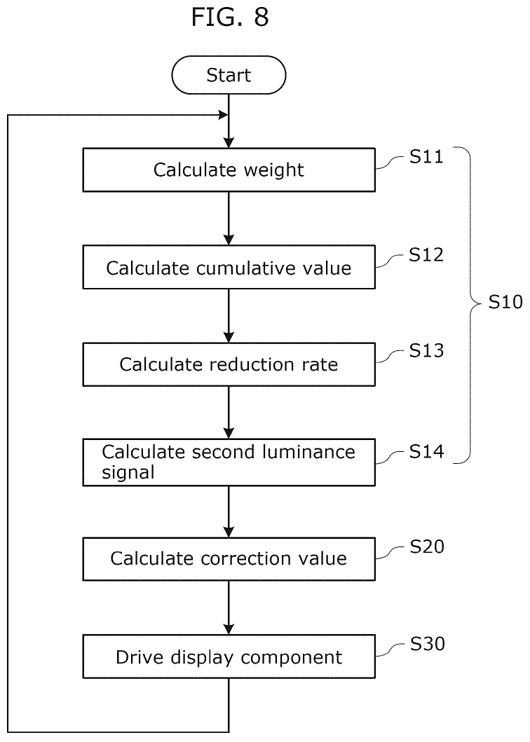

A driving method of display device 1 in the present embodiment will be described by using FIG. 8. FIG. 8 is a flowchart illustrating the flow of the driving method of display device 1 according to the present embodiment.

As illustrated in FIG. 8, first, converter 220 of control circuit 20 converts a plurality of first luminance signals corresponding to a plurality of pixels P to a plurality of second luminance signals (conversion step S10).

In conversion step S10, weight calculator 221 of converter 220 calculates a weight corresponding to the lighting period of the display component, based on the plurality of first luminance signals or the plurality of second luminance signals (weight calculation step S11).

Subsequently, cumulative value calculator 224 calculates a cumulative value that is an accumulation of a value corresponding to the weight (cumulative value calculation step S12). In the present embodiment, cumulative value calculator 224 calculates, as a cumulative value, a value that is an accumulation of a value corresponding to the period obtained by multiplying the weight and the period from the time when driving of display device 1 is started

Subsequently, reduction rate calculator 225 calculates the reduction rate for reducing each of the plurality of first luminance signals based on the cumulative value (reduction rate calculation step S13).

Subsequently, multiplier 226, which is an example of the second luminance signal calculator, calculates a plurality of second luminance signals based on the reduction rate and the plurality of first luminance signals (second luminance signal calculation step S14).

Subsequently, correction value calculator 230 calculates a plurality of correction signals obtained by correcting the plurality of second luminance signals (correction value calculation step S20). Hereinafter, an example of the operation of correction value calculator 230 in correction value calculation step S20 will be described with reference to FIG. 4.

Correction value calculator 230 calculates a correction signal to be supplied to pixel P to be corrected, so that the actual display luminance of pixel P to be corrected becomes the same as the actual display luminance of a reference pixel to which the second luminance signal is supplied.

Multiplier 231 multiplies the second luminance signal with (1/η0) as illustrated in FIG. 4. Here, the actual display luminance (that is, initial (that is, at the time of starting of driving of display device 1) actual display luminance L) of undegraded pixel P is represented by η0×I. I is a current value (corresponding to the luminance signal).

Multiplier 232 multiplies an output signal (L/η0) from multiplier 231 with (1/Δη) calculated by degradation amount calculator 233 which will be described later. The residual rate Δη is the percentage of the current actual display luminance with respect to the initial actual display luminance in pixel P to be corrected. Note that, in display panel 110, a multiplication result L/(η0×Δη) of multiplier 232 is equivalent to the current value that needs to flow to pixel P, so as to obtain the actual display luminance in an initial state.

Degradation amount calculator 233 calculates the residual rate (=1−degradation rate) by using the multiplication result in multiplier 232. The residual rate is an example of the amount of degradation, and is specified by using, for example, the percentage of a residual actual display luminance, which is the current actual display luminance of pixel P with respect to the initial actual display luminance of pixel P (the residual actual display luminance/the initial actual display luminance).

Note that, although the amount of degradation can be derived from the amount of current that has actually flowed to pixel P, since it is difficult to directly measure the amount of current, the amount of current is derived by a calculation in the present embodiment. Specifically, the amount of current is derived by, for example, the multiplication result L/(η0×Δη) in multiplier 232.

Multiplier 234 multiplies the second luminance signal with (1/Δη) calculated by degradation amount calculator 233.

Correction gradation calculator 235 converts the luminance signal L/Δη, which has been adjusted so that the initial actual display luminance L is generated in degraded organic EL element OEL, to a gradation that is to be specifically set to display component 10. The relationship between the gradation and the luminance is set in advance, and the gradation corresponding to the luminance signal L/Δη will be selected in correction gradation calculator 235. Correction gradation calculator 235 outputs a plurality of correction signals corresponding to the selected gradation to display component 10.

Subsequently, control circuit 20 inputs the plurality of correction signals to display component 10, thereby driving display component 10 based on the plurality of correction signals (driving step S30).

By repeating the same operation after this, it is possible to cause the plurality of pixels P included in display component 10 to emit light at the luminance corresponding to the plurality of second luminance signals.

### 3. Advantageous Effects etc.

The driving method of display device 1 according to the present embodiment is a driving method of display device 1 that includes display component 10 including a plurality of pixels P. The driving method includes: conversion step S10 of converting a plurality of first luminance signals corresponding to the plurality of pixels P to a plurality of second luminance signals; and driving step S30 of driving display component 10 based on the plurality of second luminance signals. Conversion step S10 includes: weight calculation step S11 of calculating a weight corresponding to a lighting period of display component 10, based on the plurality of first luminance signals or the plurality of second luminance signals; cumulative value calculation step S12 of calculating a cumulative value that is an accumulation of a value corresponding to the weight; reduction rate calculation step S13 of calculating, based on the cumulative value, a reduction rate at which each of the plurality of first luminance signals is to be reduced; and second luminance signal calculation step S14 of calculating the plurality of second luminance signals, based on the reduction rate and the plurality of first luminance signals.

Accordingly, in the determination of the reduction rate, the reduction rate corresponding to an effective lighting period can be determined by using the cumulative value of a value corresponding to the weight, instead of the lighting period of the plurality of pixels P. Therefore, the reduction rate can be determined based on the more correctly estimated degree of degradation of the plurality of pixels P. Accordingly, it is possible to inhibit the attractiveness of display device 1 from being reduced by decreasing the luminance of the plurality of pixels P more than necessary, and to inhibit the life of display device 1 from being shortened by increasing the luminance more than necessary as compared with the degree of degradation of the plurality of pixels P.

Furthermore, in weight calculation step S11, the weight may be calculated based on the APL of either the plurality of first luminance signals or the plurality of second luminance signals.

Accordingly, it is possible to accurately calculate the weight corresponding to the effective lighting period for the plurality of pixels P.

Furthermore, in weight calculation step S11, the weight may be calculated based on the maximum luminance of either the plurality of first luminance signals or the plurality of second luminance signals.

Accordingly, it is possible to accurately calculate the weight corresponding to the effective lighting period of pixel P with the largest load (that is, pixel P that is most likely to be degraded) among all of the plurality of pixels P.

Furthermore, in weight calculation step S11, the weight may be calculated based on the average of maximum luminances of either the plurality of first luminance signals or the plurality of second luminance signals in a predetermined period.

Accordingly, it is possible to accurately calculate the weight corresponding to the effective lighting period of pixel P with the largest load (that is, pixel P that is most likely to be degraded) among all of the plurality of pixels P. In addition, by calculating a weight based on the average of the maximum luminances in the predetermined period, it is possible to inhibit occurrence of a situation in which, due to large temporary fluctuation in luminance, the weight cannot represent the effective lighting period of pixel P.

Furthermore, reduction rate calculation step S13 may include: calculating a plurality of color-specific reduction rates each corresponding to a different one of a plurality of emission colors; and selecting, as the reduction rate, a minimum color-specific reduction rate among the plurality of color-specific reduction rates.

Accordingly, since the reduction rate can be determined according to pixel P of the most degraded emission color, the progression of degradation of the pixel can be inhibited to a minimum.

Display device 1 according to the present embodiment includes display component 10 including a plurality of pixels P. Display device 1 includes converter 220 that converts a plurality of first luminance signals corresponding to the plurality of pixels P to a plurality of second luminance signals. Converter 220 includes: weight calculator 221 that calculates a weight corresponding to a lighting period of display component 10, based on the plurality of first luminance signals or the plurality of second luminance signals; cumulative value calculator 224 that calculates a cumulative value that is an accumulation of a value corresponding to the weight; reduction rate calculator 225 that calculates, based on the cumulative value, a reduction rate at which each of the plurality of first luminance signals is to be reduced; and a second luminance signal calculator (multiplier 226) that calculates the plurality of second luminance signals, based on the reduction rate and the plurality of first luminance signals. Display component 10 is driven based on the plurality of second luminance signals.

Accordingly, the same effects as the driving method of display device 1 according to the present embodiment can be achieved.

### Embodiment 2

A driving method of a display device and the like according to Embodiment 2 will be described. The driving method of the display device according to the present embodiment is different from the driving method of display device 1 according to Embodiment 1 in that not only the luminance signal, but also an ambient temperature is considered in calculation of a weight. Hereinafter, a description will be given of the driving method of the display device and the like according to the present embodiment, focusing on the differences from the driving method of display device 1 according to Embodiment 1.

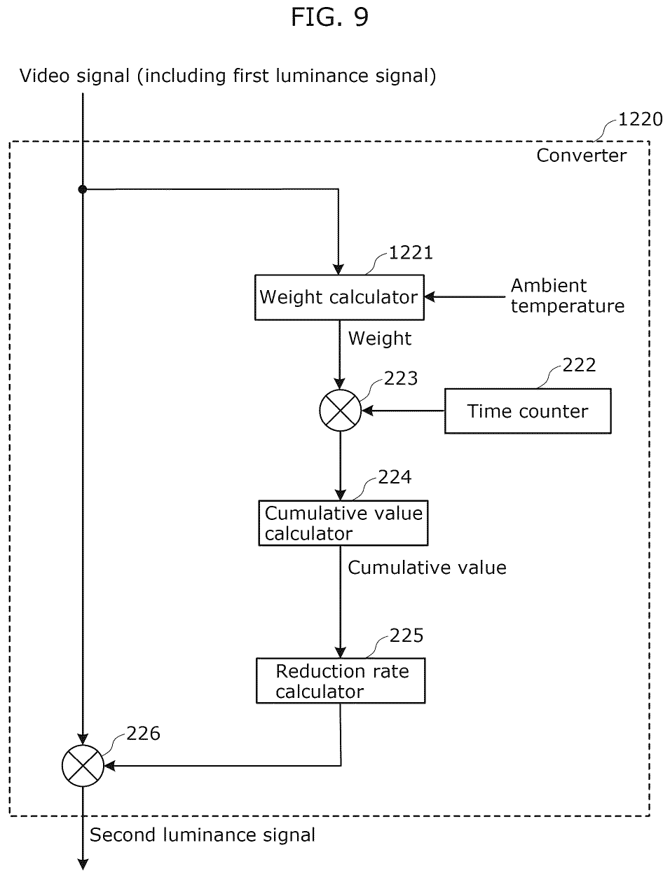

A display device according to the present embodiment will be described. The display device according to the present embodiment is different from display device 1 according to Embodiment 1 in the configuration of a converter. A converter according to the present embodiment will be described by using FIG. 9. FIG. 9 is a block diagram illustrating the configuration of converter 1220 according to the present embodiment.

As illustrated in FIG. 9, converter 1220 according to the present embodiment includes weight calculator 1221, time counter 222, multiplier 223, cumulative value calculator 224, reduction rate calculator 225, and multiplier 226.

Weight calculator 1221 according to the present embodiment calculates a weight based on a plurality of first luminance signals or a plurality of second luminance signals, and the ambient temperature of the display device. The ambient temperature means the temperature of an environment where the display device is arranged. In other words, in the driving method of the display device according to the present embodiment, in the weight calculation step, a weight is calculated based on a plurality of first luminance signals or a plurality of second luminance signals, and the ambient temperature of the display device.

Weight calculator 1221 obtains information corresponding to the ambient temperature. The information corresponding to the ambient temperature may be obtained by the display device, or may be obtained by weight calculator 1221 from the outside of the display device. For example, converter 1220 may include a temperature detector that obtains information corresponding to the ambient temperature.

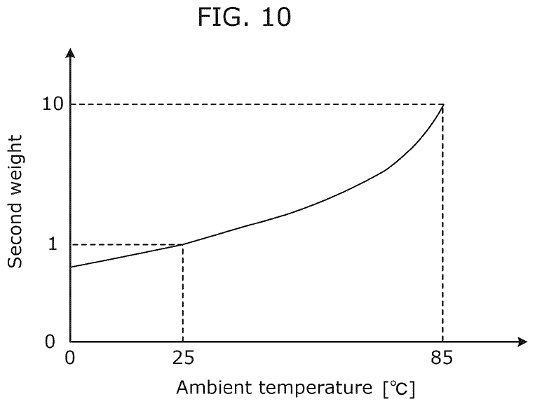

Weight calculator 1221 calculates a weight based on, for example, a plurality of first luminance signals or a plurality of second luminance signals, in a manner similar to weight calculator 221 according to Embodiment 1. In the present embodiment, the weight calculated based on the plurality of first luminance signals or the plurality of second luminance signals is referred to as a first weight. In addition, weight calculator 1221 calculates a second weight based on the ambient temperature. Here, a calculation method of the weight in weight calculator 221 will be described by using FIG. 10. FIG. 10 is a graph illustrating an example of the relationship between the ambient temperature and the second weight according to the present embodiment. As illustrated in FIG. 10, the second weight is, for example, a value of 0 or more to 10 or less, and is increased as the ambient temperature is increased. Weight calculator 1221 calculates the second weight by using, for example, the graph as illustrated in FIG. 10, a function for the ambient temperature and the second weight, a look-up table, or the like. Weight calculator 1221 outputs, for example, the product of the first weight and the second weight as the weight.

As described above, with the display device driving method according to the present embodiment, in the weight calculation step, the weight is calculated based on an ambient temperature of the display device.

In a pixel using an organic EL element or the like, the higher the ambient temperature, the faster the degradation. Therefore, by calculating a weight based on the ambient temperature as in the present embodiment, it is possible to more accurately estimate the degradation of a plurality of pixels. Therefore, it becomes possible to calculate a more appropriate reduction rate.

Note that, in the present embodiment, although weight calculator 1221 calculates the weight based on the plurality of first luminance signals and the ambient temperature, the weight may be calculated based only on the ambient temperature. That is, weight calculator 1221 may output the above-described second weight as the weight. Also in such a configuration, the degradation of a plurality of pixels can be accurately estimated. Such a configuration is particularly effective when the plurality of first luminance signals are close to an expected value, and fluctuation is small.

### Other Forms

### Variations etc. of Embodiments

Hereinbefore, a display device and a driving method for driving the display device according to the above aspects have been described based on exemplary embodiments, but the present disclosure is not limited to these embodiments. One or more aspects may include forms achieved by making various modifications to the above embodiments that can be conceived by those skilled in the art, as well as forms achieved by combining constituent elements in embodiments and variations, without materially departing from the spirit of the present disclosure.

For example, the weight calculation method by weight calculator 1221 according to Embodiment 2 may be combined with each configuration described in Embodiment 1.

In addition, the circuit configuration of the plurality of pixels P is not limited to the example illustrated in FIG. 3. As the circuit configuration of the plurality of pixels P, other known circuit configurations may be applied.

In addition, in the above-described embodiments, although the video signal is an RGB signal, a signal other than the RGB signal may be included in the video signal. That is, it is sufficient for the video signal to include an RGB signal.

In addition, the video signal is not limited to a signal including an RGB signal. For example, the video signal may be a color difference signal including a luminance signal.

In addition, in the above-described embodiments, although the example has been illustrated in which the organic EL element is used as the self-luminous element, the self-luminous element is not limited to this. For example, a quantum dot, an inorganic EL element, or the like may be used as a self-luminous element.

In addition, one or more of the constituent elements included in the display device (the control circuit in particular) according to each of the embodiments described above may be a computer system including a microprocessor, ROM, random-access memory (RAM), and a hard disk unit, for example. A computer program is stored in the RAM or the hard disk unit. The function is achieved as a result of the microprocessor operating according to the computer program. Here, the computer program is configured by combining a plurality of instruction codes indicating instructions to the computer in order to fulfill a given function.

In addition, one or more of the constituent elements included in the display device according to each of the embodiments described above may be configured as a single system large scale integration A system LSI is a super multifunctional LSI (LSI) circuit. manufactured by integrating a plurality of elements on a single chip, and is specifically a computer system including, for example, a microprocessor, ROM, and RAM. A computer program is stored in the RAM. The system LSI circuit fulfills the functions as a result of the microprocessor operating according to the computer program.

In addition, one or more of the constituent elements included in the display device according to each of the embodiments described above may be configured as an integrated circuit (IC) card or standalone module attachable to and detachable from each device. The IC card or module is a computer system including, for example, a microprocessor, ROM, and RAM. The IC card or module may include the above-described super multifunctional LSI. The IC card or module fulfills the functions as a result of the microprocessor operating according to a computer program. The IC card or module may be tamperproof.

In addition, one or more of the constituent elements included in the display device according to each of the embodiments described above may be a computer-readable recording medium, such as a flexible disk, hard disk, CD-ROM, magneto-optical (MO) disc, digital versatile disc (DVD), DVD-ROM, DVD-RAM, Blu-ray Disc (BD; registered trademark), semiconductor memory, etc., having recording thereon the computer program or the digital signal. One or more of the constituent elements included in the display device according to each of the embodiments described above may be the digital signal recorded on the recording medium.

In addition, one or more of the constituent elements included in the display device according to each of the embodiments described above may transmit the computer program or the digital signal via, for example, a telecommunication line, a wireless or wired communication line, a network such as the Internet, or data broadcasting.

In addition, the present disclosure may be the methods described above. The present disclosure may be a computer program implementing these methods with a computer, or a digital signal of the computer program. In addition, the present disclosure may be implemented as a non-transitory computer-readable recoding medium, such as CD-ROM, having the computer program recorded thereon.

In addition, the present disclosure may be implemented as a computer system including (i) memory having the computer program stored therein, and (ii) a microprocessor that operates according to the computer program.

In addition, the present disclosure may be implemented by another independent computer system by recording the program or the digital signal on the recording medium and transporting it, or by transporting the program or the digital signal via the network, etc.

The above embodiments and above variations may be arbitrarily combined.

### INDUSTRIAL APPLICABILITY

The driving method of the display device and the display device according to the present disclosure are useful in the technical field of displays for flat TVs, personal computers, and the like.

1. A display device driving method of driving a display device that includes a display component including a plurality of pixels, the display device driving method comprising:
converting a plurality of first luminance signals corresponding to the plurality of pixels to a plurality of second luminance signals; and
driving the display component based on the plurality of second luminance signals, wherein
the converting includes:
calculating a weight corresponding to a lighting period of the display component, based on the plurality of first luminance signals or the plurality of second luminance signals;
calculating a cumulative value that is an accumulation of a value corresponding to the weight;
calculating, based on the cumulative value, a reduction rate at which each of the plurality of first luminance signals is to be reduced; and
calculating the plurality of second luminance signals, based on the reduction rate and the plurality of first luminance signals.

2. The display device driving method according to claim 1, wherein
in the calculating of the weight, the weight is calculated based on an average picture level (APL) of either the plurality of first luminance signals or the plurality of second luminance signals.

3. The display device driving method according to claim 1, wherein
in the calculating of the weight, the weight is calculated based on a maximum luminance of either the plurality of first luminance signals or the plurality of second luminance signals.

4. The display device driving method according to claim 3, wherein
in the calculating of the weight, the weight is calculated based on an average of maximum luminances in a predetermined period, the maximum luminances each being the maximum luminance.

5. The display device driving method according to claim 1, wherein
in the calculating of the weight, the weight is calculated based on an ambient temperature of the display device.

6. The display device driving method according to claim 1, wherein
the plurality of pixels include pixels corresponding to a plurality of emission colors, and
the calculating of the reduction rate includes: calculating a plurality of color-specific reduction rates each corresponding to a different one of the plurality of emission colors; and selecting, as the reduction rate, a minimum color-specific reduction rate among the plurality of color-specific reduction rates.

7. A display device that includes a display component including a plurality of pixels, the display device comprising:
a converter that converts a plurality of first luminance signals corresponding to the plurality of pixels to a plurality of second luminance signals, the converter including:
a weight calculator that calculates a weight corresponding to a lighting period of the display component, based on the plurality of first luminance signals or the plurality of second luminance signals;
a cumulative value calculator that calculates a cumulative value that is an accumulation of a value corresponding to the weight;
a reduction rate calculator that calculates, based on the cumulative value, a reduction rate at which each of the plurality of first luminance signals is to be reduced; and
a second luminance signal calculator that calculates the plurality of second luminance signals, based on the reduction rate and the plurality of first luminance signals, wherein
the display component is driven based on the plurality of second luminance signals.
